(19) United States
(12) Patent Application Publication
(10) Pub. No.: US 2025/0167868 A1
(43) Pub. Date: May 22, 2025

(54) SYSTEMS AND METHODS FOR COVERAGE ENHANCEMENT IN NON TERRESTRIAL NETWORK

(71) Applicant: ZTE CORPORATION, Shenzhen (CN)

(72) Inventors: Fangyu CUI, Shenzhen (CN); Nan ZHANG, Shenzhen (CN); Yachao YIN, Shenzhen (CN); Junli LI, Shenzhen (CN)

(73) Assignee: ZTE CORPORATION, Shenzhen (CN)

(21) Appl. No.: 19/035,604

(22) Filed: Jan. 23, 2025

Related U.S. Application Data
(63) Continuation of application No. PCT/CN2022/122418, filed on Sep. 29, 2022.

(51) Int. Cl. H04B 7/06; H04L 5/00; H04W 76/20; H04W 84/06

(52) U.S. Cl. CPC H04B 7/06968; H04L 5/0051; H04W 76/20; H04W 84/06

(57) ABSTRACT

Presented are systems and methods for coverage enhancement in non-terrestrial networks (NTN). A wireless communication device may determine a time window. The wireless communication device may send at least one uplink transmission according to the time window to a wireless communication node.

### CROSS-REFERENCE TO RELATED APPLICATION

This application claims the benefit of priority under 35 U.S.C. § 120 as a continuation of PCT Patent Application No. PCT/CN2022/122418, filed on Sep. 29, 2022, the disclosure of which is incorporated herein by reference in its entirety.

### TECHNICAL FIELD

The disclosure relates generally to wireless communications, including but not limited to systems and methods for coverage enhancement in non-terrestrial network (NTN).

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments (e.g., including combining features from various disclosed examples, embodiments and/or implementations) can be made while remaining within the scope of this disclosure.

At least one aspect is directed to a system, method, apparatus, or a computer-readable medium of the following. A wireless communication device may determine a time window. The time window comprises at least one of a quasi colocation (QCL) window or DMRS bundling time window. The time window may have a length that is at most equal to a segment length for performing pre-compensation (e.g., timing advance (TA) pre-compensation). The wireless communication device may send at least one uplink transmission according to the time window to a wireless communication node. The time window may comprise at least one of: a demodulation reference signals (DMRS) bundling time window; or a quasi colocation (QCL) window. The at least one uplink transmission may comprise a plurality of demodulation reference signals (DMRS) sent within the DMRS bundling time window. The plurality of DMRS can be bundled. The at least one uplink transmission may be sent within the QCL window. The at least one uplink transmission shares same channel property.

In some embodiments, the wireless communication device may receive an indication of the length of the time window via a first signaling from the wireless communication node. The first signaling may comprise at least one of: a dedicated radio resource control (RRC) signaling, or a system information block (SIB) signaling.

In some embodiments, a length of the time window can be determined based on predefined or stored information. The predefined or stored information can be for a type of network. The type of network may comprise at least one of: a low earth orbit (LEO) network or a geostationary earth orbit (GEO) network.

In some embodiments, the wireless communication device may receive an indication of the segment length for performing pre-compensation, via a second signaling, from the wireless communication node. The second signaling may comprise at least one of: a dedicated radio resource control (RRC) signaling, or a system information block (SIB) signaling.

In some embodiments, a length of the time window can be configured independent of the segment length for performing pre-compensation. In certain embodiments, a length of the time window can be shorter than the segment length.

In some embodiments, a length of the time window can be configured based on the segment length. In certain embodiments, a length of the time window can be equal to the segment length.

In some embodiments, the length of the time window can be determined as: L_{timewindow}=min(L_{timewindow,config}, L_{segment}), where L_{timewindow} is the determined time window length, L_{timewindow,config} is the time window length indicated via a first signaling, and L_{segment} is the segment length indicated via a second signaling.

In some embodiments, a wireless communication node (e.g., a network) may receive at least one uplink transmission according to a time window from a wireless communication device (e.g., a UE). The time window can be determined by the wireless communication device. The time window may have a length that is at most equal to a segment length for performing pre-compensation.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example non-terrestrial network (NTN), in accordance with some embodiments of the present disclosure;

FIG. 4 illustrates segmented pre-compensation, in accordance with some embodiments of the present disclosure; and

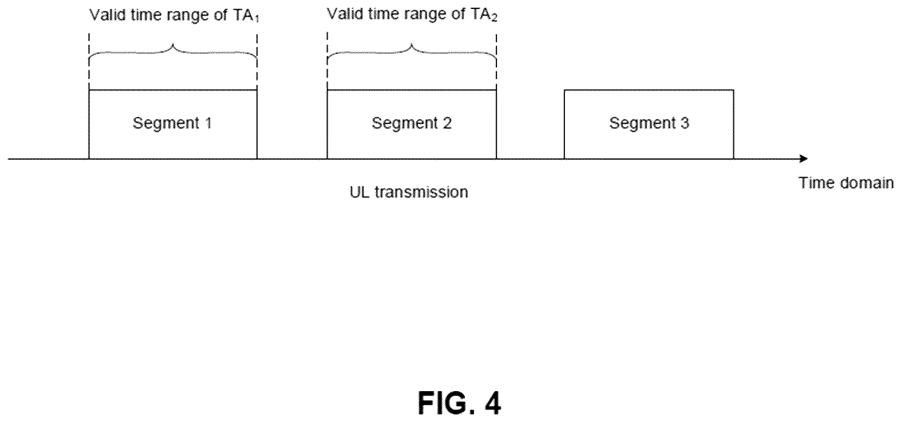

FIG. 5 illustrates a flow diagram for coverage enhancement in non-terrestrial network (NTN), in accordance with an embodiment of the present disclosure.

### DETAILED DESCRIPTION

### 1. Mobile Communication Technology and Environment

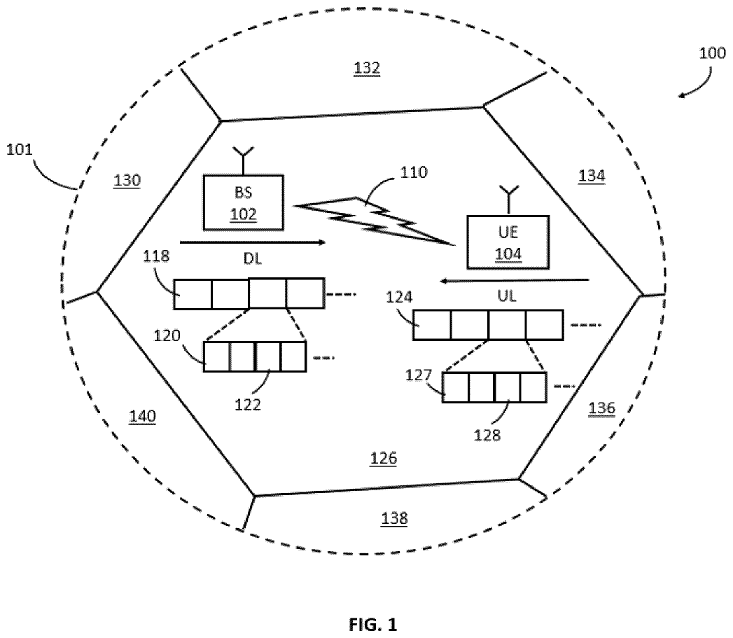

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

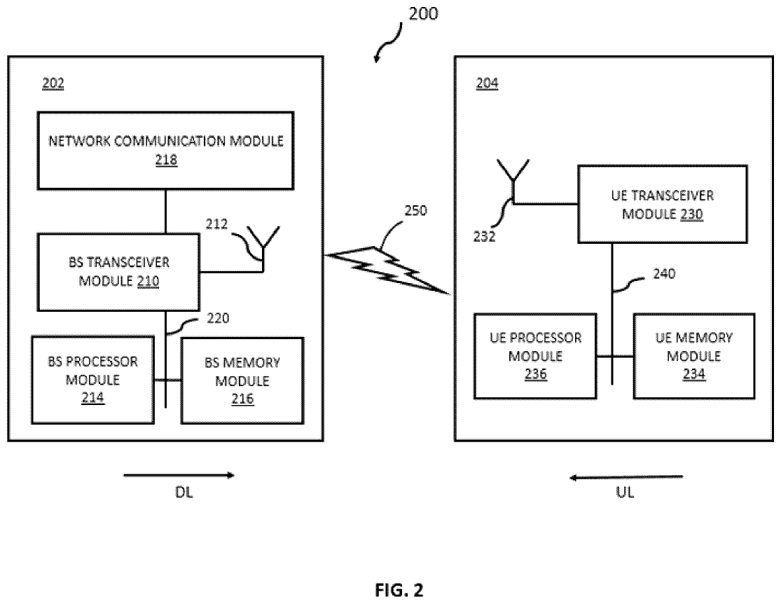

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Coverage Enhancement in Non-Terrestrial Network (NTN)

A coverage enhancement for non-terrestrial network (NTN) may mitigate performance loss due to a large distance between a user equipment (UE) and a satellite. An enhancement for terrestrial network (TN) may comprise a demodulation reference signal (DMRS) bundling and/or a joint channel estimation (JCE). However, due to a high mobility of a satellite in NTN, timing drift may be fast and a timing advance (TA) pre-compensation value may be adjusted frequently. The DMRS with different TA pre-compensations may not be coherent and may not be bundled. In this disclosure, how to bundle the DMRS with a consideration of TA pre-compensation is investigated. The systems and methods presented herein include novel approaches for coverage enhancement in non-terrestrial network.

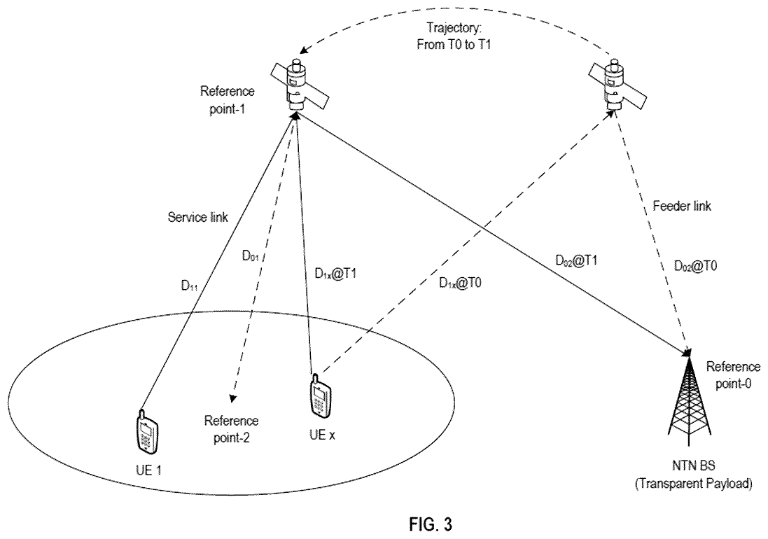

FIG. 3 illustrates an example representation of a NTN, e.g., a transparent NTN. In some embodiments, the link between a UE and a satellite may be a service link. The link between a base station (BS) and a satellite may be a feeder link. The feeder link can be common for all UEs within the same cell.

In TN systems, methods for coverage enhancement may include: repetition and/or joint channel estimation (JCE). For the repetition method, a transmitter can repetitively transmit a message for a period of time. A receiver can combine the repetition of the transmissions and may increase the performance of decoding. For the joint channel estimation (JCE) method, reference signals (RSs) at different time instances can be used jointly to estimate a channel. The JCE may provide a better estimation of channel and/or better decoding performance. In the JCE method, the DMRS can be bundled, such as considered quasi colocation (QCL) in the channel estimation.

Segmented pre-compensation may apply different pre-compensation of timing advances (TAs) and/or frequency offsets for different components of a single uplink (UL) transmission. In order to avoid the timing offset/frequency offset (TO/FO) exceeding a tolerable range, the pre-compensated TA and/or Doppler may be adjusted after a period of time to mitigate the timing and/or frequency drift caused by a satellite mobility. When the adjustment period is shorter than a total time of a single transmission (with multiple repetitions), the transmission may be divided into multiple segments. Each segment may apply or be subject to a TA and/or a Doppler pre-compensation value.

### Implementation Example 1: DMRS Bundling With a Consideration of Segmented Pre-Compensation

A demodulation reference signal (DMRS) bundling can be considered as a method to enhance coverage performance. The DMRS bundling can be used to estimate reference signaling in a channel. The DMRS bundling may comprise/use/involve a plurality of demodulation reference signals (DMRSes). In an uplink (UL) transmission, the DMRSes in multiple slots can be bundled, e.g., for channel estimation. The DMRSes within same bundle are considered coherent. The DMRSes within a DMRS bundling time window may be bundled, e.g., for channel estimation. Likewise, some or all (e.g., types of) signals with a QCL window may be grouped or bundled for specific purposes and/or to have certain characteristics, For instance, the DMRSes within the same bundle may be highly correlated with each other. In such case, a joint channel estimation (JCE) across the multiple slots can be performed to improve the channel estimation performance. A detection performance of data can be improved accordingly. A larger DMRS bundle size may improve JCE performance.

However, if segmented pre-compensation is performed, the TA applied at/on different segments can be different. The time/frequency coherence of the signals in different segments may be degraded. In such case, the DMRSes in different segments may not be considered as QCLed. As a result, the DMRSes bundling across multiple segments may not provide better performance.

A UE may determine a time window. The time window may have a length that is at most equal to a segment length for performing pre-compensation. The time window comprises at least one of a quasi colocation (QCL) window or DMRS bundling time window. The UE may send at least one uplink transmission according to the time window to the network. The at least one uplink transmission may comprise a plurality of demodulation reference signals (DMRS) sent within the DMRS bundling time window. The plurality of DMRS (e.g., within the QCL window) may be bundled. In certain embodiments, the plurality of DMRS is to be used for joint channel estimation (JCE). The UE may receive an indication of the length of the QCL window via a first signaling from the network. The UE may receive an indication of the segment length for performing pre-compensation, via a second signaling (e.g., RRC or SIB signaling), from the network.

In some embodiments, the length of the time window can be at most equal to a segment length for performing (TA and/or other) pre-compensation. The time window can affect or apply to signals within the window, such as DMRSes for DMRS bundling purposes. The time window may be a QCL window. The QCL window may comprise different reference signals, such as a DMRS and/or a sounding reference signal (SRS). Configuration methods of DMRS bundling for NTN may comprise at least one of: (i) A length of a QCL window/DMRS bundling time window can be directly configured by the network via a system information block (SIB) broadcast or a dedicated radio resource control (RRC) signaling. (ii) A length of a QCL window/DMRS bundling time window can be determined based on predefined or stored information. For example, different DMRS bundling sizes can be defined for different types of networks. The predefined or stored information can be for a type of network. The type of network may comprise at least one of: a low earth orbit (LEO) network or a geostationary earth orbit (GEO) network. Information of different DMRS bundling sizes for different types of networks (e.g., a LEO network and a GEO network) can be listed/stored/specified/maintained in a predefined table. (iii) A length of a QCL window/DMRS bundling time window can be determined according to both DMRS bundling sizes obtained through the previous two options and/or a segment length for pre-compensation. Both DMRS bundling sizes and segmented pre-compensation can be considered/enabled. If the configured DMRS bundling size is larger than the segment length of pre-compensation, a final DMRS bundling size can be equal to the segment length. The final DMRS bundling size can be L_{DMRSbundling}=min(L_{DMRSbundling,config}, L_{segment}). (iv) A length of a QCL window/DMRS bundling time window can be equal to a segment length. As discussed above, the DMRS bundle size may be large, but may not be larger than the segment length of pre-compensation. Hence, directly setting the DMRS bundling size equal to segment length can be a suitable choice. In such case, only one indication can be enough. In certain embodiments, since a segment length configuration is supported in a NTN system, the DMRS bundling size may be set/configured as the segment length directly without additionally defining a signaling for a DMRS bundling size configuration.

A DMRS bundling size can be configured based on at least one of: (1) predefined/pre-stored information; (2) a SIB broadcast signaling; or (3) a dedicated RRC signaling. In some embodiments, when a segment length is indicated by a network, the DMRS bundling size may be determined as at least one of: (1) a configured DMRS bundling size independent of/regardless of the segment length; (2) a smaller/minimum value of the configured DMRS bundling size and the segment length for pre-compensation (e.g., L_{DMRSbundling}=min(L_{DMRSbundling,config}, L_{segment})); (3) the segment length for pre-compensation independent of/regardless of the DMRS bundling size configuration. In some embodiments, for method (2), the DMRS bundling size L_{DMRSbundling} can be further reduced so that the segment length L_{segment} is divisible by L_{DMRSbundling}.

### Implementation Example 2: Frame Combing Length and DMRS Bundling

In a NTN, a voice service can be a key issue to be investigated. In the voice service, a latency can be one important constraint. Due to the latency constraint, each voice frame may be transmitted within 20 ms. As a result, at most 20 slots can be considered in DMRS bundling and joint channel estimation.

However, when frame combining is allowed in voice service, the DMRS bundling size can be larger. For example, if two voice frame can be transmitted in same transport block, a maximum allowed latency can be 40 ms. The average latency for each frame can be still 20 ms. Although the code rate is basically not changed, a larger DMRS bundling window can be obtained. With more DMRS in JCE, the channel estimation performance can be better and whole detection performance may be improved.

In some embodiments, network may indicate a frame combining length/factor to the UE via a SIB broadcast, a dedicated RRC signaling, or a higher layer signaling. The DMRS bundling size can be equal to the product of configured DMRS bundling and the frame combining length/factor.

In some embodiments, network may indicate a frame combining length/factor to the UE via a SIB broadcast, a dedicated RRC signaling, or a higher layer signaling. A segment length can be determined based on a configured segment length and frame combining length/factor. The UE may ensure the frequency offset (FO) is smaller than a threshold for a segment of UL transmission.

### Implementation Example 3: Msg4 HARQ-ACK PUCCH Repetition

In a NR system, a repetition of msg4 HARQ-ACK PUCCH repetition may not be supported. In a NTN, due to large propagation loss, detection performance of msg4 HARQ-ACK PUCCH can be poor and may not satisfy the requirement. In order to mitigate the performance loss, repetition of msg4 HARQ-ACK PUCCH can be supported. Two repetitions can be enough to satisfy the performance requirement in a NTN scenario. Therefore, at least one of following signaling methods can be supported: (i) The network may indicate UE 1 bit signaling. When 0 is indicated or the signaling is not indicated, the msg4 HARQ-ACK PUCCH repetition may not be supported. When 1 is indicated, the msg4 HARQ-ACK PUCCH repetition may not be supported and the repetition number can be 2. (ii) The network may indicate UE 1 bit signaling. When 1 is indicated or the signaling is not indicated, the msg4 HARQ-ACK PUCCH repetition may not be supported. When 0 is indicated, the msg4 HARQ-ACK PUCCH repetition may not be supported and the repetition number can be 2. The signaling can be indicated in a SIB broadcast, a MAC CE, a dedicated RRC signaling, or an msg4 carried in the PDSCH.

It should be understood that one or more features from the above implementation examples are not exclusive to the specific implementation examples, but can be combined in any manner (e.g., in any priority and/or order, concurrently or otherwise).

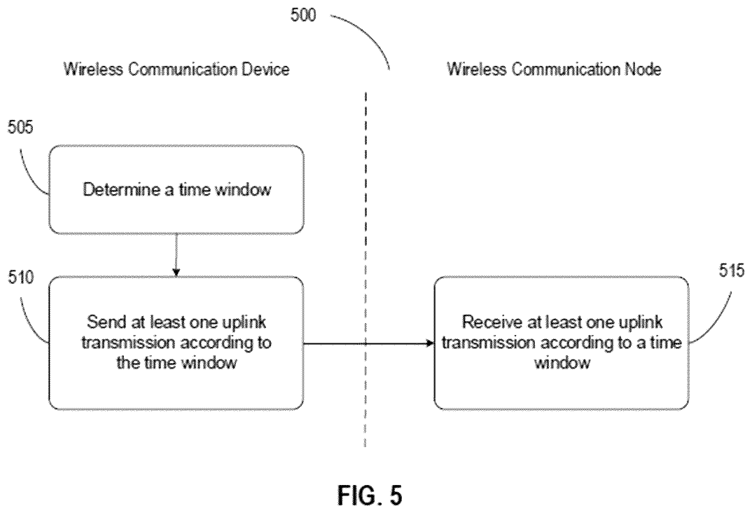

FIG. 5 illustrates a flow diagram for coverage enhancement in non-terrestrial network (NTN), in accordance with an embodiment of the present disclosure. The method 500 may be implemented using any one or more of the components and devices detailed herein in conjunction with FIGS. 1-2. In overview, the method 500 may be performed by a wireless communication device, in some embodiments. Additional, fewer, or different operations may be performed in the method 500 depending on the embodiment. At least one aspect of the operations is directed to a system, method, apparatus, or a computer-readable medium.

A wireless communication device may determine a time window. The time window comprises at least one of a QCL window or a DMRS bundling time window. The time window may have a length that is at most equal to a segment length for performing one or more types of pre-compensation. The wireless communication device may send at least one uplink transmission according to the time window to a wireless communication node. The time window may comprise at least one of: a demodulation reference signals (DMRS) bundling time window; or a quasi colocation (QCL) window.

The at least one uplink transmission may comprise a plurality of demodulation reference signals (DMRS) sent within the DMRS bundling time window. The plurality of DMRS (e.g., occurring within the DMRS bundling time window or the bundling size) can be bundled. The at least one uplink transmission sent within the QCL window may share same channel property

In some embodiments, the wireless communication device may receive an indication of the length/size/duration of the time window via a first signaling from the wireless communication node. The first signaling may comprise at least one of: a dedicated radio resource control (RRC) signaling, or a system information block (SIB) signaling.

In some embodiments, a length of the time window can be determined based on predefined and/or stored information. The predefined and/or stored information can be for a type of network. The type of network may comprise at least one of: a low earth orbit (LEO) network or a geostationary earth orbit (GEO) network.

In some embodiments, the wireless communication device may receive an indication of the segment length for performing pre-compensation, via a second signaling, from the wireless communication node. The second signaling may comprise at least one of: a dedicated radio resource control (RRC) signaling, or a system information block (SIB) signaling.

In some embodiments, a length of the time window can be configured independent of the segment length for performing pre-compensation. In certain embodiments, a length of the time window can be shorter than (or equal to) the segment length.

In some embodiments, a length of the time window can be configured based on the segment length. In certain embodiments, a length of the time window can be (e.g., configured to be) equal to (or shorter than, or a specific fraction of) the segment length.

In some embodiments, the length of the time window can be determined as: L_{timewindow}=min(L_{timewindow,config}, L_{segment}), where L_{timewindow} is the determined time window length, L_{timewindow,config} is the time window length indicated via a first signaling, and L_{segment} is the segment length indicated via a second signaling.

In some embodiments, a wireless communication node (e.g., of a network, such as a base station) may receive at least one uplink transmission (e.g., a plurality of DMRSes) according to (e.g., bundled within or according to) a time window from a wireless communication device (e.g., a UE). The time window can be determined by the wireless communication device. The time window may have a length that is at most equal to a segment length for performing pre-compensation. The wireless communication node may receive and/or use the at least one uplink transmission to perform joint channel estimation and/or pre-compensation (e.g., to calculate/generate a TA pre-compensation value).

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method, comprising:
determining, by a wireless communication device, a time window; and
sending, by the wireless communication device to a wireless communication node, at least one uplink transmission according to the time window.

2. The method of claim 1, wherein the time window comprises at least one of:
a demodulation reference signals (DMRS) bundling time window; or
a quasi colocation (QCL) window.

3. The method of claim 1, wherein the at least one uplink transmission comprises a plurality of demodulation reference signals (DMRS) sent within the DMRS bundling time window, and
wherein the plurality of DMRS is bundled.

4. The method of claim 1, wherein the at least one uplink transmission sent within a quasi colocation (QCL) window shares same channel property.

5. The method of claim 1, comprising:
receiving, by the wireless communication device from the wireless communication node, an indication of a length of the time window via a first signaling.

6. The method of claim 5, wherein the first signaling comprises at least one of: a dedicated radio resource control (RRC) signaling, or a system information block (SIB) signaling.

7. The method of claim 1, wherein at least one of:
a length of the time window is determined based on predefined or stored information, or the predefined or stored information is for a type of network, and the type of network comprises at least one of: a low earth orbit (LEO) network or a geostationary earth orbit (GEO) network.

8. The method of claim 1, comprising:
receiving, by the wireless communication device from the wireless communication node, an indication of a segment length for performing pre-compensation, via a second signaling.

9. The method of claim 8, wherein the second signaling comprises at least one of: a dedicated radio resource control (RRC) signaling, or a system information block (SIB) signaling.

10. The method of claim 1, wherein a length of the time window is configured independent of a segment length for performing pre-compensation.

11. The method of claim 1, wherein a length of the time window is shorter than a segment length.

12. The method of claim 1, wherein a length of the time window is configured based on a segment length.

13. The method of claim 1, wherein a length of the time window is equal to a segment length.

14. The method of claim 1, wherein a length of the time window is determined as:
L_{timewindow}=min(L_{timewindow,config}, L_{segment})
where L_{timewindow} is a determined time window length, L_{timewindow,config} is the time window length indicated via a first signaling, and L_{segment} is a segment length indicated via a second signaling.

15. A method, comprising:
receiving, by a wireless communication node from a wireless communication device, at least one uplink transmission according to a time window,
wherein the time window is determined by the wireless communication device.

16. A wireless communication node, comprising:
at least one processor configured to:
receive, via a receiver from a wireless communication device, at least one uplink transmission according to a time window,
wherein the time window is determined by the wireless communication device.

17. A wireless communication device, comprising:
at least one processor configured to:
determine a time window; and
send, via a transmitter to a wireless communication node, at least one uplink transmission according to the time window.

18. The wireless communication device of claim 17, wherein the time window comprises at least one of:
a demodulation reference signals (DMRS) bundling time window; or
a quasi colocation (QCL) window.

19. The wireless communication device of claim 17, wherein the at least one uplink transmission comprises a plurality of demodulation reference signals (DMRS) sent within the DMRS bundling time window, and
wherein the plurality of DMRS is bundled.

20. The wireless communication device of claim 17, wherein the at least one uplink transmission sent within a quasi colocation (QCL) window shares same channel property.
